(19) United States
(12) Patent Application Publication
(10) Pub. No.: US 2005/0131751 A1
(43) Pub. Date: Jun. 16, 2005

(54) Method and an apparatus for computer-implemented evaluation of client business processes

(76) Inventors: Juergen Ahlers, Gross-Rohrheim (DE); Hermann Eichert, Frankenstein (DE); Johannes Musseleck, Worms (DE); Heiner Gorrissen, Ludwigshafen (DE); Udo Muller, Ludwigshafen (DE)

Correspondence Address: NOVAK DRUCE DELUCA & QUIGG, LLP, 1300 EYE STREET NW, SUITE 400 EAST, WASHINGTON, DC, 20036, US

(21) Appl. No.: 10/496,665

(22) PCT Filed: Nov. 26, 2002
(86) PCT No.: PCT/EP02/13277

(30) Foreign Application Priority Data
Nov. 26, 2001 (DE) 101 58 843.7

(51) Int. Cl. G06F 17/60

(52) U.S. Cl. 705/10

(57) ABSTRACT

The invention relates to a method and a device for the computer-implemented evaluation of electronic business processes using a computer system. In order to check the business process-relevant data contained in a business process (GP) received by the computer system, a static examination of data on the basis of character recognition is carried out in a first step and hypotheses on the content of every examined date are established. In a second step, a dynamic examination of the established hypotheses is carried out. According to the invention, a synchronization of the electronically recognized data contents with client- and/or material-specific data contained in a data base (200) is performed.

The present invention relates to a method and an apparatus for the computer-implemented evaluation of electronic customer business processes and a computer program with programming code which when run on a computer system is adapted to carry out the method according to the invention, and a storage medium containing a computer program of this kind.

The term “evaluation” within the scope of this invention comprises the recognition, structuring and working of business processes. Business processes are, for example, orders, delivery plans, invoices, changes to orders, enquiries, etc. These may be processes within the company between one department representing the customer and another department representing the supplier, and also processes between individual companies and their external clients. The processes which can be run using a system according to the invention include all possible areas of commercial and industrial life. In particular, the system according to the invention is also suitable in conjunction with the control of industrial manufacturing and production processes.

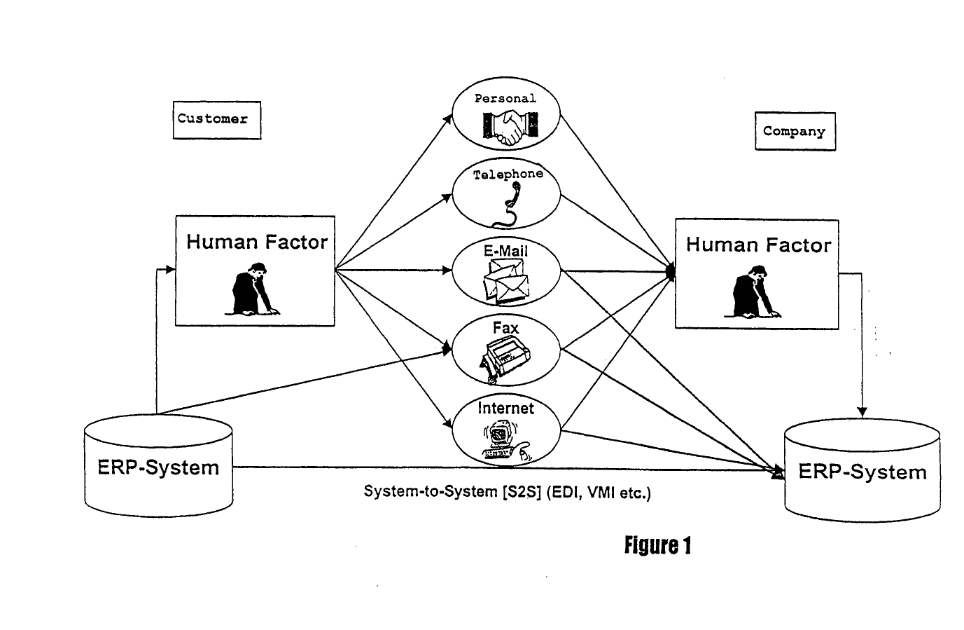

In evaluating so-called client business processes human intervention is generally necessary at least on one of the two sides involved (client/customer and recipient of the business/supplier). Exceptions to this are so-called system-to-system processes (S2S processes) in which two company systems matched to one another (ERP systems; ERP: enterprise resource planning) communicate directly with one another and exchange data. FIG. 1 shows a diagrammatic representation of the paths of communication in typical customer business processes. On the left hand side of FIG. 1 the customer (client) is shown while on the right hand side is shown the company receiving the contract (supplier). On both sides, apart from the above mentioned case of the S2S process, the involvement of a human being is generally required. If ERP systems tuned to one another are used on both sides (which is usually only economically viable with large customers with a high volume of orders), the business processes taking place over the internet or fax may do away with the intervention of human agency at least on one side.

Particularly in business processes which use e-mail (electronic mail) and faxes, the problem with human intermediaries is significant. Typically, at the customer end, an e-mail or fax message from one person (generally using a computer, a workstation or the like) is drafted and sent to the supplier. At the supplier end, also, typically the incoming e-mail or fax is dealt with by an employee and relevant data is fed into the company's own system. Thus, data which was originally electronically generated is fed into an electronic data processing device by human intervention. Only in those cases where the customer uses an electronic form provided by the supplier and set up in accordance with the supplier's ERP system is it possible to have an incoming e-mail or fax further processed directly by the supplier's ERP system.

In a conventional order over the telephone, the customer gives his order verbally to an employee of the supplier who then inputs this order into the in-house order system of the supplier. Depending on the structure in the company accepting the order, the order has to be passed on to an authorised person before being input into the system and this person then inputs the order. The customer does not receive an official confirmation of the order until the order has been input into the system.

In the case of ordering over the internet, (e-commerce solution) the customers manually input the information required through a browser. This solution involves additional effort for the customer as the customer generally has already recorded the entry in his own ordering system and now has to input the entry all over again manually.

In practice, therefore, it has proved extremely difficult to connect the EDP (Electronic Data processing) systems of customers to the corresponding systems of the supplier. Generally, the customers are not prepared to make the necessary investment in EDP hardware and software. Nor are they usually prepared to adapt their existing and usually branch-specific EDP standards to those used by the supplier. In particular for potential suppliers with a heterogeneous circle of customers it is also extremely difficult to introduce in-house standards which can be matched to customer requirements and to the different EDP systems of the customers.

DE 197 06 419 A1 discloses a method for controlling business processes using a technology for mechanical speech processing. In the known method, at least one of the conditions of an activity of the business process is automatically examined.

There are also systems on the market in which, within the scope of electronic incoming post processing, incoming business documents are scanned in and then automatically recognised, evaluated and passed on to the appropriate employee for further processing.

Therefore, the invention provides for a method and an apparatus for computer-implemented evaluation of customer business processes having the features set forth in claims 1 and 6, and claims 9 and 14, respectively, which allows a user to process incoming business processes fully automatically without human interference on the part of the supplier, and without the customer having to use data structures or forms provided by the supplier. Orders can be sent by electronic mail (e-mail), by fax or by telephone.

Accordingly, in order to examine data relevant to business processes which are contained in a business process (GP) input into the computer system, in a first checking step the data are statically examined on the basis of character recognition and hypotheses are drawn up as to the content of each piece of examined data, and in a second checking step the hypotheses drawn up are dynamically checked. In another embodiment of the invention, in order to examine business process relevant data contained in a business process (GP) input into the computer system, electronically recognised data contents are compared with customer- and/or material-specific data contained in a knowledge base (200).

According to the invention, for this purpose, the ordering system used by the supplier (and any other EDP system present including databanks) are combined with an image and/or text recognition system which is capable of extracting the information and data required from the customer forms sent to the supplier and making them directly available to the in-house ERP system without human intervention.

According to an advantageous embodiment of the invention the ordering system used is combined with a telephone (speech) recognition system which recognises speech and/or keystroke information over the telephone and converts it into digital data which can be processed by the internal ordering system.

Preferably, a regular exchange and comparison of data takes place between the EDP system of the supplier and the recognition system which is additionally provided according to the invention, as a result of which the quota of errors in recognising the customer data can be reduced considerably and thus the speed of processing can be improved.

In a further preferably embodiment of the invention, the image and/or text recognition system capable of identifying the customer and the relevant order details in unformatted orders and other business processes (for example letters written in body copy or e-mails) and conveying them to the in-house system of the supplier. This can be done by using a databank which is fed from an existing system (e.g. a business warehouse system) with information specific to the customer and/or materials. In this way the information and data recognised in an incoming document can be compared and if necessary corrected or supplemented. The comparison of data takes place using stored data and historical information filed in the warehouse system. Using this process logic the system is capable of independently recognising the customer, for example, and interpreting the contents of the order fully and without errors and automatically generating an order for the in-house ERP system. According to the invention, thus, stored data systems and so-called data warehouses (this term referring to large, structured, distributed data stocks of longstanding value and preferably used for queries and analysis) are connected to recognition systems.

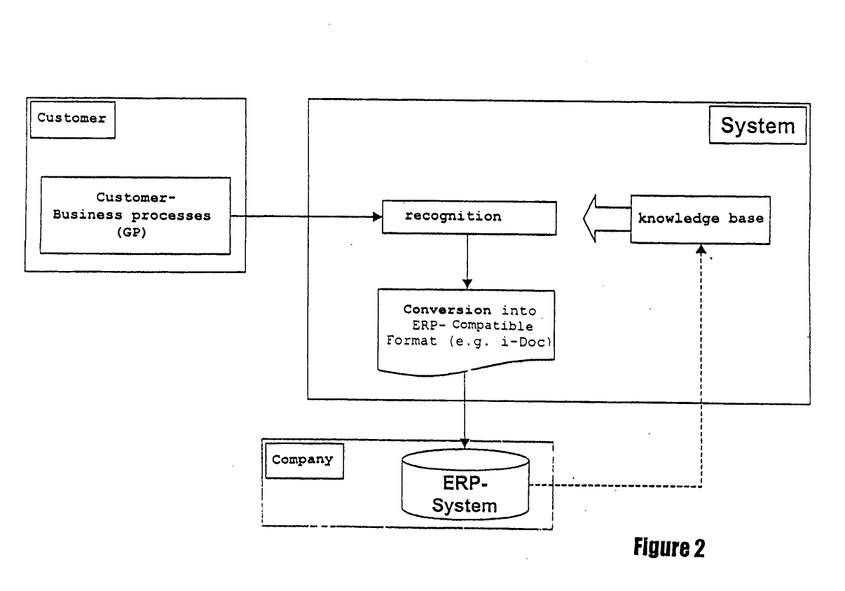

The recognition provided by the recognition systems proceeds in two stages according to the invention. In a first stage there is character recognition known per se in which the information sent by a customer is converted into a format which the in-house system can understand. This is done for example using so-called OCR software (OCR=optical character recognition), i.e. the optical recognition of clear text. In a second stage the contents of the document are recognised, i.e. the semantic content of the data and information transmitted. This stage is preferably carried out by a combination of artificial intelligence, semantic text recognition or non-specific comparisons and linking with stored data systems and data warehouses (for historical information). After this, the “knowledge” obtained by the two steps of recognition is converted into a format which can be understood by the in-house system of the supplier. The procedure according to the invention described above is illustrated in the highly schematic function diagram shown in FIG. 2.

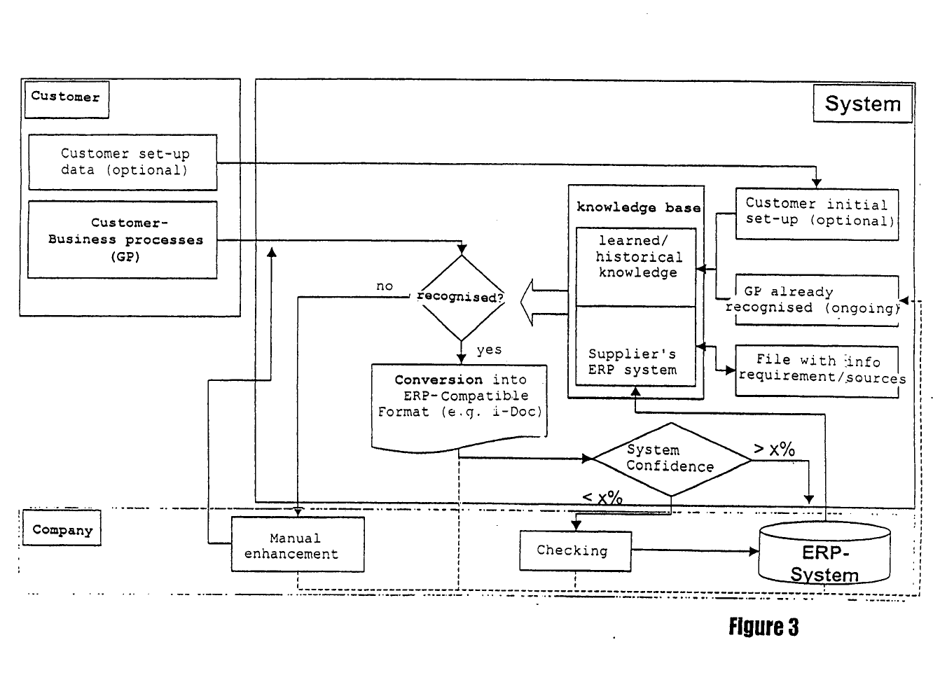

FIG. 3 shows a rather more detailed schematic function diagram in which the partial sequences, particularly within the recognition system, are shown in more detail. The recognition system (labelled “system” for short in FIG. 3) receives a customer business process GP. Optionally with the (first) customer business process the customer can also transmit so-called setup data to the system. These initial setup data are stored in the system in the knowledge base which includes learned/historical knowledge. The business process received is examined by the system, particularly using the data available in the knowledge base, i.e. learned/historic knowledge and supplier-ERP system information. If the customer business process is recognised (yes) the recognised information is converted into a format which is compatible with the in-house ERP system. If the customer business process is not recognised (no) then manual inspection and amendment of the business process received can be carried out, particularly in the implementation phase of the system according to the invention. The amended version is then fed back into the recognition system to run the recognition process.

A business process recognised by the recognition system passes through a system confidence interrogation after conversion into an ERP-compatible format. This takes place particularly in the implementation or initial phase of operation of the system according to the invention when the recognition rate is still below a preset threshold. If the recognition probability is insufficient (recognition rate<x %) the business process recognised undergoes further examination before being passed in the ERP system of the supplier.

In order to develop the system according to the invention still further, data and information obtained from the recognition process, particularly recognised business processes, are stored in the knowledge base (indicated by broken lines in the function diagram). This may be done by storing the forms or features of forms and the associated recognition results, particularly those supplemented by manual intervention, or by transferring the ordering data generated without the use of ordering forms, i.e. a dynamic improvement of the knowledge base.

The invention also includes computer programs with program coding means which are suitable for performing a method according to the invention when the computer program is run on a computer, and computer-readable data carriers with computer programs according to the invention stored thereon and computer program products with computer-readable data carriers of this kind.

Further features and advantages of the invention are described in the claims and will become apparent from the description and accompanying drawings.

It will be realised that the features mentioned above and those to be described hereinafter may be used not only in the combination specified but also in other combinations or on their own without departing from the scope of the present invention.

The invention is schematically illustrated in the drawings with reference to additional embodiments and is described in detail hereinafter with reference to the drawings.

FIG. 1 is a schematic view to illustrate the problem on which the invention is based.

FIG. 2 is a highly schematic functional diagram of the invention.

FIG. 3 shows a more detailed representation of the functional diagram of FIG. 2.

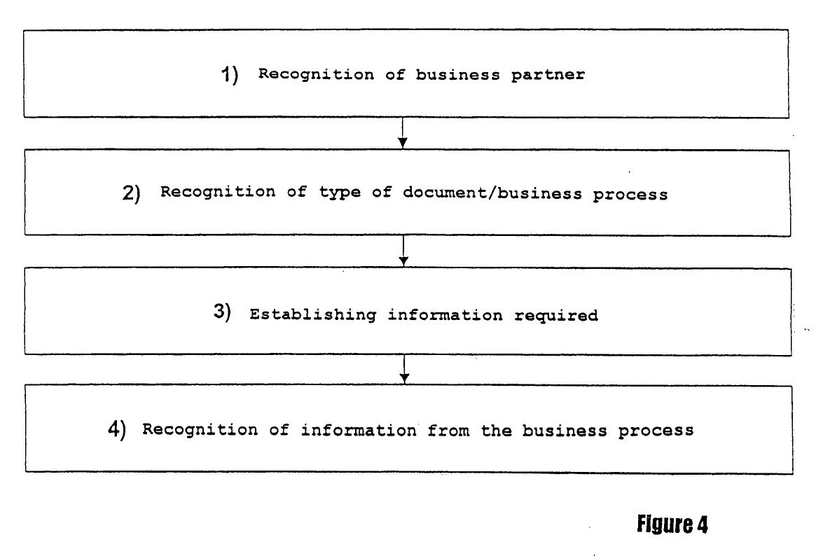

FIG. 4 shows the different recognition steps according to the invention.

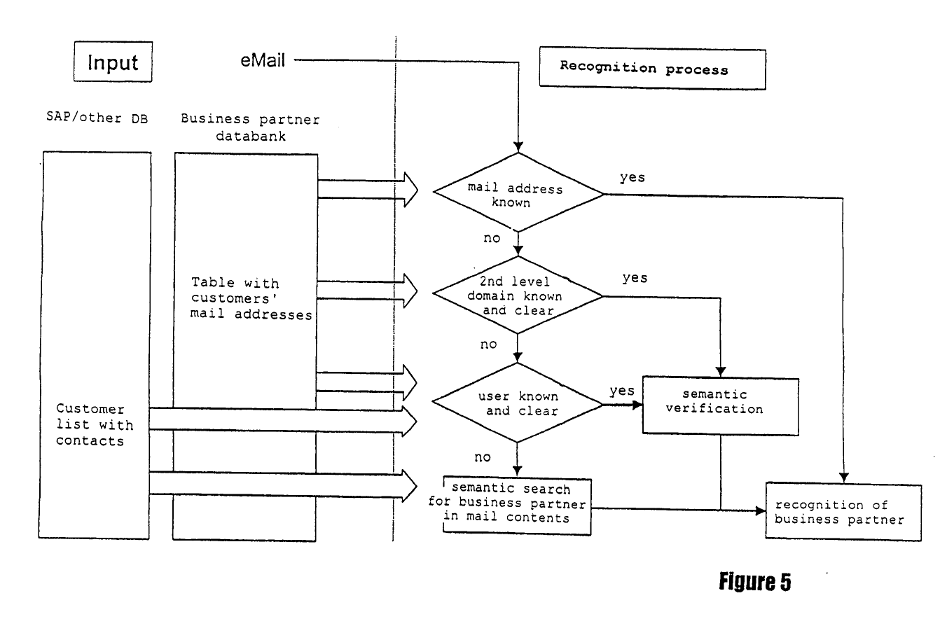

FIG. 5 shows by means of a flow diagram the schematic process for recognition according to the invention of a business partner in the case of electronic mail (e-mail).

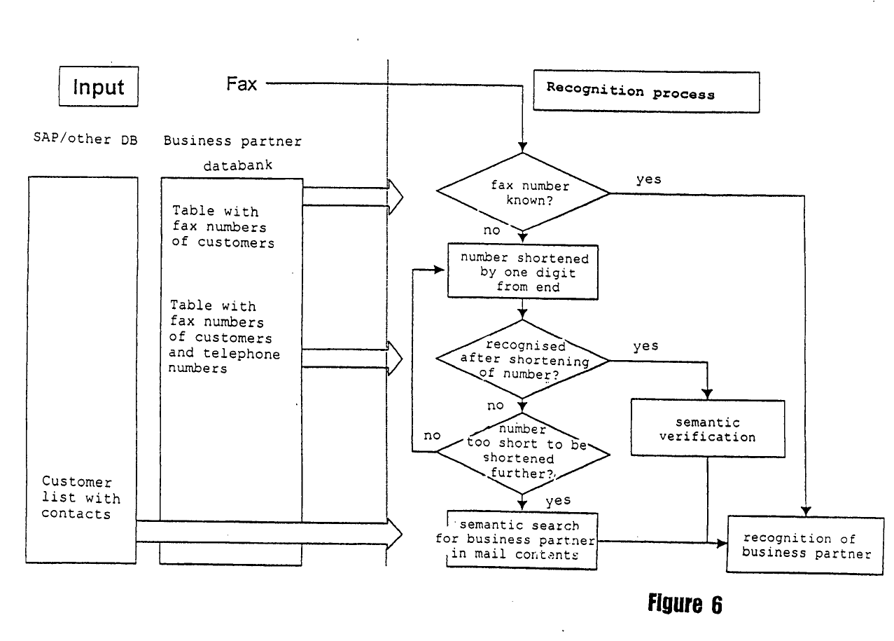

FIG. 6 shows by means of a flow diagram the schematic process for recognition according to the invention of the business partner in the case of a fax message.

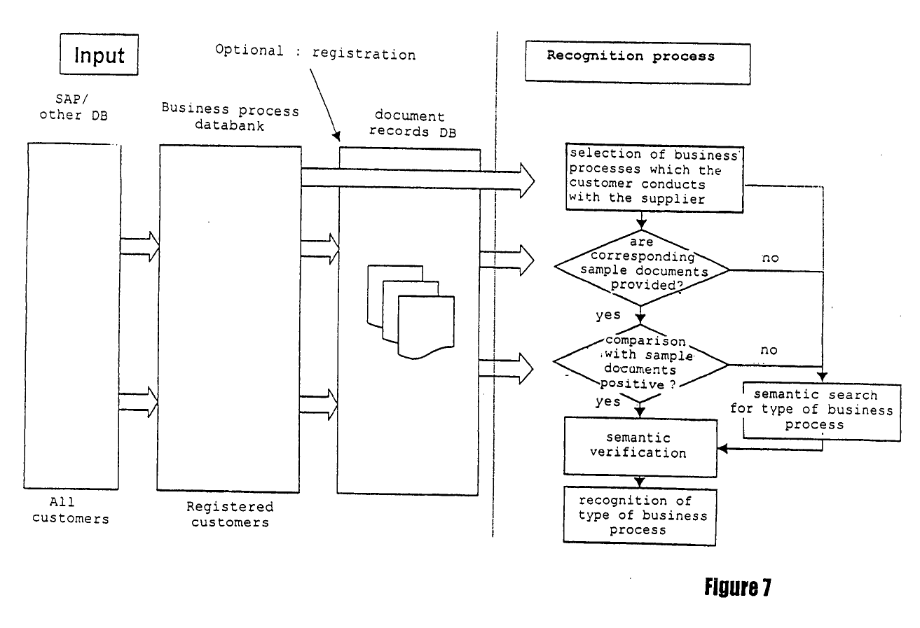

FIG. 7 shows by means of a flow diagram the schematic process of recognition according to the invention of the type of document or the business process.

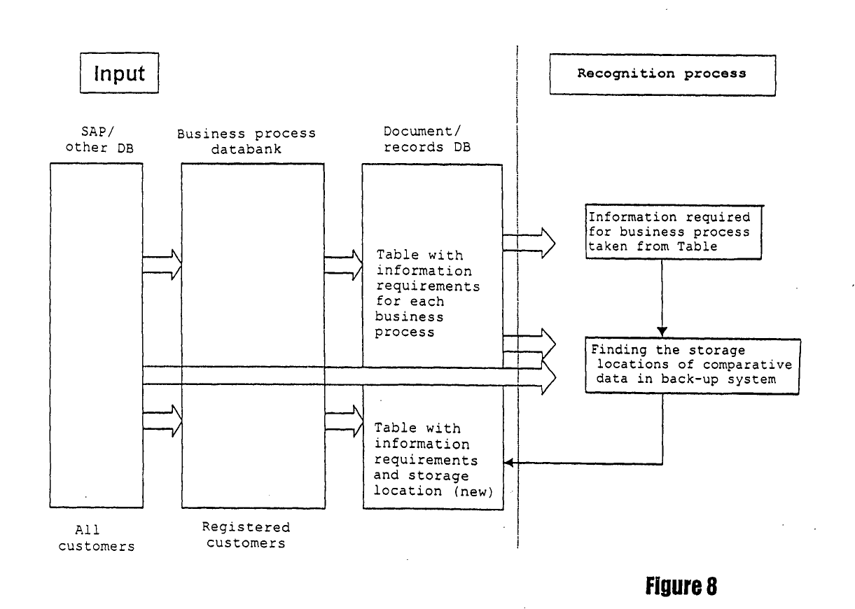

FIG. 8 is a schematic representation of the recognition or detection of the information requirement.

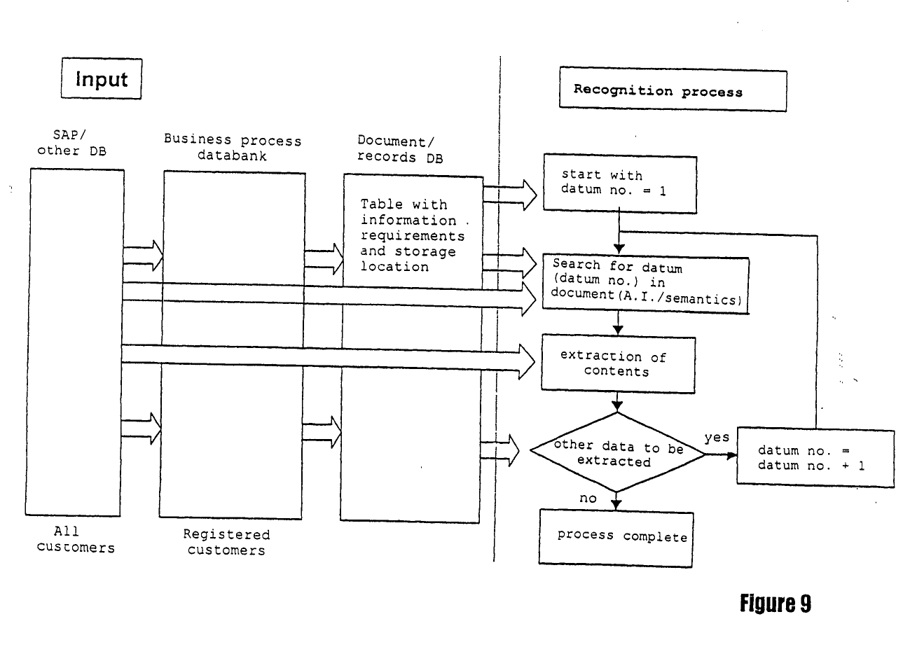

FIG. 9 is a schematic flow diagram representation showing the recognition according to the invention of information from the business process transmitted.

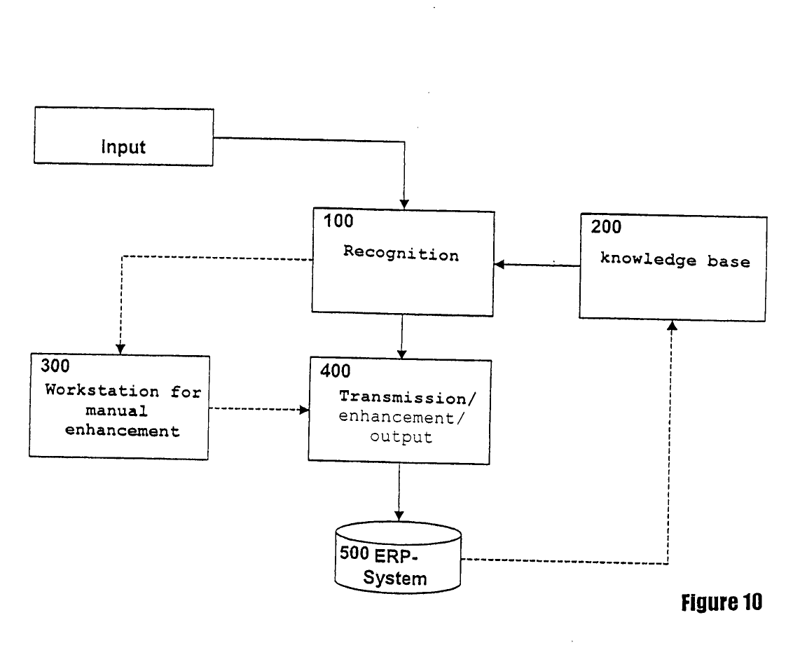

FIG. 10 shows a schematic overview of a system architecture according to the invention.

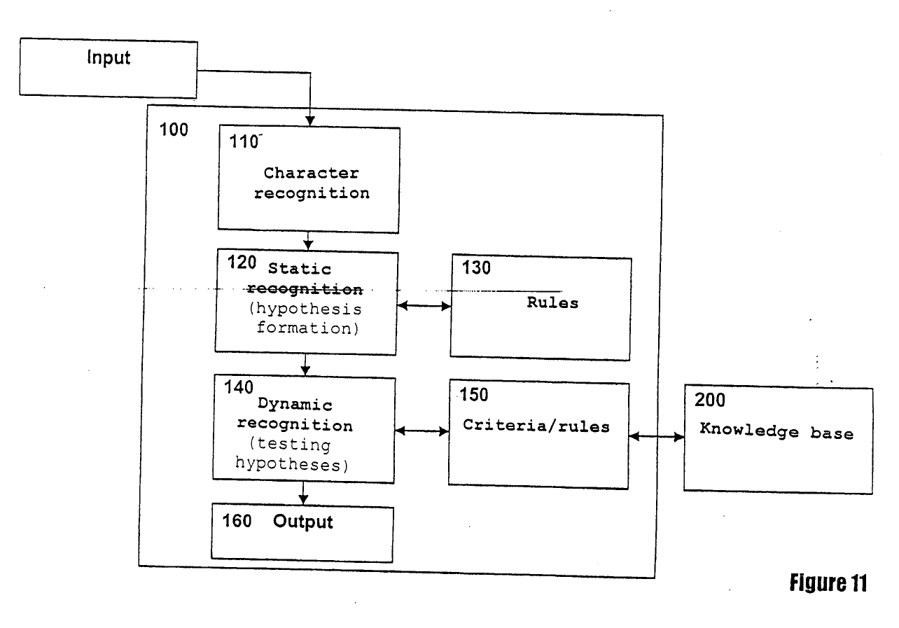

FIG. 11 shows a schematic representation of the structure of the recognition module (Module 100).

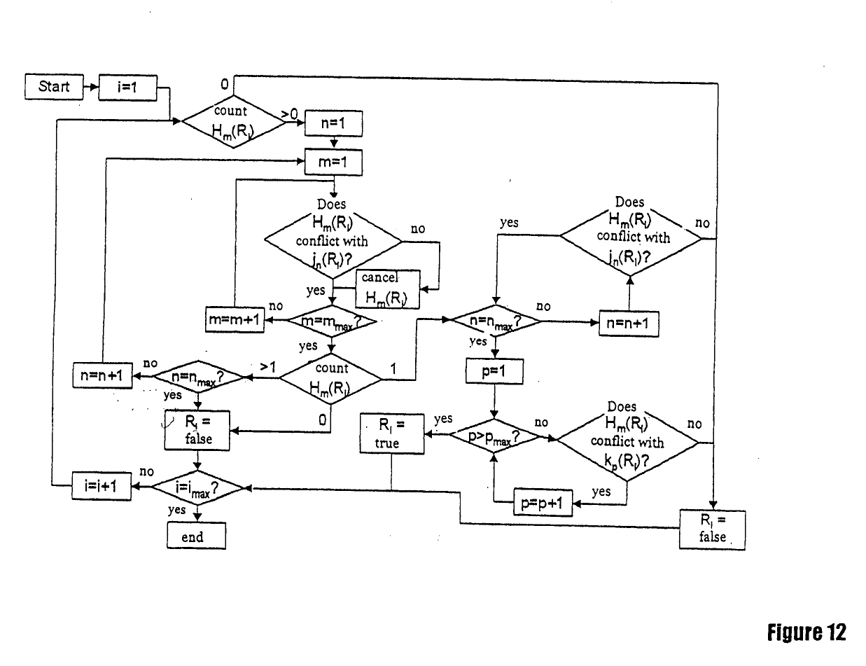

FIG. 12 illustrates by means of a flow diagram the method according to the invention for dynamically recognising the contents of a document.

FIG. 5 schematically shows by way of example the process of recognition of the business partner/customer in the case of electronic mail (e-mail). The description by way of example starts from a structure of an e-mail address by the conventional standard, namely user@2ld.tld, where 2ld is the second level domain and tld is the top level domain. (The procedure described is naturally appropriate in those cases where not all the customers have been provided with an individual e-mail address by the supplier to which orders can be sent as the business partner is then tied to the incoming mail address and recognition is therefore trivial. The same is also true of the allocation of individual fax numbers or telephone numbers.)

After electronic mail has been received, the e-mail address of the sender (customer) is compared with the mail addresses stored in the business partner's databank. For the example described here the mail address of the sender is “meier@schroeder.de”. If this mail address is stored in the business partner database the business partner is recognised immediately and the second step “recognition of the type of document/business process” can proceed (see FIG. 4).

If this mail address is not present in the business partner databank the second level domain (in the present instance “schroeder”) is investigated using the business partner data-bank and optionally the data stocks in the in-house ERP system (customer list).

If no company is found having the same or similar name or part of the name “schroeder”, in the next step the user name (in this instance “meier”) is investigated. If a customer with the name “Meier” is found in the data stocks of the ERP system, the company for which he works has to be compared with the data known from the second level domain. If the customer Meier works for a company with the name Schroeco AG, for example, it can be established by means of the data stored that this is a holding company to which a company Schröder GmbH belongs.

Using subsequent semantic verification or fuzzy analysis an investigation is made to see whether Mr Meier of Schroeco AG is likely to be the business partner sought.

If this third step of checking should also be unsuccessful, as a final possibility, the business partner is found by means of a semantic/fuzzy search through the entire contents of the electronic mail. The information to be recognised may thus also refer to the information recognised in another recognition stage.

An analogous procedure takes place when a business process is sent by fax. The recognition process is then carried out on the basis of the fax number of the business partner (cf. FIG. 6).

FIG. 7 illustrates the second step “recognition of the type of document/of the business process” in the recognition process according to the invention, as shown in FIG. 4. Depending on the particular embodiment, this second step may also be interchanged with the first, i.e. it may take place before the recognition of the business partner. This is particularly advisable when only a few business processes are supported by the procedure, e.g. during the initial phase of system implementation. In the present embodiment, on the other hand, the starting procedure is as shown in FIG. 4, in which the recognition of the type of document or business process is the second step.

In this second step first of all the information as to what business processes the customer has with the supplier/contractor is called up from the business process databank. For the company Schroeco AG already mentioned by way of example it is found that this company has previously carried out the processes “delivery plan” and “order”. A check is then made to see whether corresponding examples of documents are present in the document databank. If they are, a comparison is run to see whether the documents received are identical to the documents on file. If this is the case or very nearly the case, a semantic or fuzzy test is run to determine whether the present document is an order or a delivery plan, with sufficiently great certainty/probability. The result might then be, for example, that Mr Meier of Schroeco AG has electronically submitted an order.

If there are no documents by way of example or a comparison with existing documents on file proves negative, a semantic/fuzzy search has to be run in the text of the message sent to determine the nature of the business process.

In step 3 “establishing the information requirement” (see FIG. 4) a table is used, as shown in FIG. 8 by way of example, to determine what data is required to fully recognise the business process (in the present example an order) and where corresponding information of value can be found in the data warehouse, for example.

To simplify greatly, it can be assumed here by way of example that the quantity and delivery date are needed to recognise an order completely. Regarding the quantity, information can be used from historic orders from the customer, i.e. Schroeco AG, and product data available from the databank such as the minimum order, etc. To determine the delivery date a calendar and also product data available from databanks such as the manufacturing time etc. may be used, for example. The information obtained is stored in the document databank.

FIG. 9 schematically shows the process sequence of the fourth and last step of “recognition of the information from the business process”. The term “datum” used here is the singular of “data” and therefore means a single piece of information.

In this recognition step the necessary data are successively extracted from the document sent. The first datum to be extracted in the embodiment by way of example is the delivery quantity. In accordance with the table provided in the document databank, a search is run in historic order data of Schroeco AG and it is found for example that in 90% of cases Schroeco AG order a quantity of 20 tons and in only 10% of cases do they order a quantity of 10 tons. From the ERP or another databank it is found that 10 tons constitutes the minimum order. On the basis of this finding the information that Schroeco AG are ordering 20 tons is extracted by semantic recognition and/or artificial intelligence/fuzzy interrogation.

The second datum to be extracted in this embodiment by way of example is the delivery date. In accordance with the table previously drawn up in the document databank, orders before the present day are excluded and with a manufacturing time of 10 days (obtained from the databank) an order for the period beginning in 10 days is considered to be most likely. Using semantic recognition and/or artificial intelligence/fuzzy interrogation the information that Schroeco AG would like a delivery in three weeks time is extracted on the basis of this finding.

### EXAMPLE AND ALGORITHM

With reference to an embodiment shown in FIG. 10 relating to order recognition, an EDP and software system according to the invention for fully automated recognition of customer orders and for transferring the read and recognised orders into an ERP (Enterprise Resource Planning) system e.g. of type SAP R/3 will now be described.

The system according to the invention comprises the modules described in more detail hereinafter, namely a recognition module 100, a knowledge base 200, an enhancement module 300, a transmission module 400 and an ERP system 500.

The recognition module 100 serves to recognise the necessary data to generate a business process (such as an order) in an ERP system. It is assumed that not all the data which have to be entered in order to generate a business process (for example an order) in an ERP system have to be recognised but rather the data to be recognised can be completed for example by material stock data and customer profile data.

The components of the recognition module 100 are as follows:
110: System for optical character recognition (OCR) based on an input file
120: System for static data recognition or for forming hypotheses as to specific file contents
130: Rules for supporting the activity of component 120
140: System for dynamic data recognition based on verification of the hypotheses formed by component 120
150: Criteria and rules for supporting the activity of component 140
160: Output device

Module 200 (knowledge base) serves to support the activity of the recognition module 100. The module 200 is a knowledge base in the form of a databank or a two-directionally responsive ERP system.

The components of the knowledge base 200 are as follows:
210: Stock data relating to materials which can be ordered, i.e. data on an assortment of relevant items
220: Stock data relating to business partners, i.e. profiles of possible customers (containing for example information on customer lists with associated identifying numbers, addresses, ordering habits, special requirements, etc.
230: Data on historical orders from relevant business partners (customer history)

The enhancement module 300 serves to manually enhance output data sets from module 200 which have not been fully recognised.

The transmission module 400 serves to enhance and reformat the data set recognised from module 200 or module 300 into a format which can be imported by the ERP system used. This is done, for example, using business integration software of the TSI Mercator® type.

The components of the transmission module 400 known per se are as follows:
410: System for enhancing the output data set received from module 200 or 300 into a data set with all the data which have to be entered in order to generate a business process (such as an order) in an ERP system.
420: Module for converting the complete data set into a format which can be imported by the ERP system used.
430: Output component for transferring the formatted data set to an ERP system

The module designated 500 is an ERP system, for example of the SAP R/3 type.

The components of the ERP system 500 are as follows:

In addition to the usual components of an ERP system the following components are essential:
510: Interface for receiving a data set as transferred from module 400
520: Interface for delivering the data described under module 200 to a knowledge base as described in module 200

### DESCRIPTION OF THE FUNCTION OF THE MODULES

The individual modules and their components and their functions will now be described in detail. For recognition of other business processes such as changes to orders, cancellations of orders, invoice processing etc. the system described can also be used according to the invention, suitably modified.

The recognition module 100 accesses a file in the component “character recognition” 110 and converts the information contained in this file into a text file (see FIG. 11). Input formats form image files, for example, of the types BMP, BW, DCX, DIB, EMF, GIB, GIF, TIF, ILBM, JFIF, JIF, JPEG, LBM, PCD, PCS, PIC, PIX, PNG, PSD, RGB, RLE, SGI, TGA, TIFF or WMA, Postscript and Reader files, e.g. of the postscript or Adobe Acrobat Reader file types, markup language files such as HTML or XML files, document files from wordprocessing systems, e.g. MicroSoft Word documents, text files e.g. of the ASCII type or Rich Text format. The recognition module 100 recognises the contents of the texts contained in these files as best it can and converts them into a text format, e.g. of the ASCII or Rich Text format type. To do this, the files are read in by optical character recognition (OCR) systems known per se and commercially available, e.g. of the aCE Docustar type, and are issued or reformatted as ASCII or Rich Text format files.

In the “static recognition” component 120, hypotheses as to the data to be recognised are developed from the file resulting from the character recognition 110. To do this, the component “Rules” 130 provides a rule mechanism with two types of rules: on the one hand rules for formatting the fields to be found (example: the date of order has the format (DD/MM/YYYY) or (DD/MM/YY) or (DD-MM-YYYY) or . . . ) and on the other hand rules as to the semantic context of the information relevant to developing the hypothesis [example: “the order number is often found close to the sequence of characters (order number)” or “the date of ordering is always before the desired delivery date”]. From this, the component “static recognition” 120 draws up hypotheses such as for example: “desired order quantity equals 10 kg”. For each datum to be recognised by the module 100, a number of (possibly contradictory) hypotheses may be formed [example: hypothesis 1 (order quantity): “desired order quantity=10 kg”, hypothesis 2 (order quantity): “desired order quantity=10000 kg”].

The hypotheses are sent for checking to component “Dynamic Recognition” 140 which examines the hypotheses obtained from the “Static Recognition” 120 using criteria and rules from the “criteria/rules” component 150 and referring back to the knowledge base 200. The corresponding checking algorithm is shown in FIG. 12.

The elements in the algorithm shown are defined as follows:
Recognition steps (resulting in the recognition of a desired datum): R
   →Counting: i; i ε {1, . . . , iₘₐₓ}
Hypothesis for a possible value of Rᵢ from the preceding process step (component 120): H(Rᵢ)
   →Counting: m; m ε {1, . . . , mₘₐₓ}
Exploratory test criterion for hypothesis Hₘ(Rᵢ): j(Rᵢ)
   →Counting: n; n ε {1, . . . , nₘₐₓ}
Confirmatory test criterion for hypothesis Hₘ(Rᵢ): k(Rᵢ)
   →Counting: p; p ε {1, . . . , pₘₐₓ}

The criteria in component 150 are divided into two categories: on the one hand into criteria which may be used for exploration (exploratory criteria j) and on the other hand into those which can be used not for exploration but only for confirmation (confirmatory criteria k). The criteria are arranged in a hierarchy within their category with the sharpest criterion of the category being first (jₗ(Rᵢ) or kₗ(Rᵢ)), the sharpness of the criteria increasing as the index number rises.

The criteria may be examined according to the module construction or criterium by a sharp yes/no query (possible results would be referred to here mathematically as 0 or 1) or by fuzzy logic. In the latter case the association of the hypothesis to be tested with a fuzzy quantity defined by the rule of the criterion and any associated data from the knowledge base can be stated in standardised terms by a value in the range [0,1]. For each criterion a confidence interval, i.e. a range within the interval must then be specified for which the hypothesis withstands the criterion when the value of the association with the fuzzy quantity falls within this range.

For the first (i=1) datum (R₁) to be found a check is carried out to find whether there are more than zero hypotheses [Hₘ(R₁)]. If this is not the case the recognition of R₁ has failed. A check is made as to whether other data to be found are missing. If this is the case the process is continued with the next datum (in this case R₂), otherwise the process is at an end.

If there are more than zero hypotheses [Hₘ(R₁)] the compatibility with the first exploratory criterion (j₁(R₁)) is tested for all available hypotheses one after the other. Any hypotheses which are not compatible with the criterion are rejected. After all the hypotheses have been tested the remaining hypotheses [Hₘ(R₁)] are counted. If the hypothesis count is more than 1 and other exploratory criteria are available, the check is repeated with the next lower criterion in the hierarchy. If no other exploratory criteria are available or if the hypothesis count came to 0 the recognition of R₁ has failed. A test is run to see whether other data to be found are absent. If this is the case the process is continued with the next datum (in this case R₂), otherwise the process is at an end.

If the hypothesis count was 1, this means that a potential solution was found. This is tested hereinafter with any other exploratory criteria and the confirmatory criteria. For this purpose a check is made as to whether all exploratory criteria have hitherto been used. If not, compatibility with the next lower exploratory criterion in the hierarchy is checked. If there is no compatibility recognition of the datum (in this case R₁) has failed. A check is made as to whether other data to be found are missing. If this is the case the process is continued with the next datum (in this case R₂), otherwise the process is at an end. This loop is run until the exploratory criterion at the bottom of the hierarchy has been used.

Then a check is made as to whether a confirmatory criterion is present. If this is not the case recognition of R₁ has succeeded. The hypothesis remaining is assigned a solution value (for example: the customer Meier was clearly found to be a customer, the hypothesis customer=Meier is assigned the customer number of the customer Meier from the database). A check is then made as to whether other data to be found are absent. If this is the case the process is continued with the next datum (in this case R), otherwise the process is at an end.

If at least one confirmatory criterion is present the compatibility of the hypothesis with the confirmatory criterion at the top of the hierarchy (in this case k₁(R₁) is tested. If there is no compatibility the recognition of the datum (in this case R₁) has failed. A test is run as to whether other data to be found are absent. If this is the case the process is continued with the next datum (in this case R₁) otherwise the process is at an end.

If compatibility is found, a check is made as to whether there are other confirmatory criteria. If this is not the case the recognition of R₁ has succeeded and the process is continued as described above. If there are other confirmatory criteria the compatibility of the hypothesis with the confirmatory criterion which is the next one down in the hierarchy (in this case k₂(R₁)) is tested. This loop is run through again until it comes to an end.

The process described with reference to the first run-through is repeated for all the data to be found.

The criteria used refer in content to the data in the knowledge base (component 200). Thus, for example, a criterion in the search for the customer (example: R₁=customer) may run as follows: “the company name specified in the hypothesis is found in this form or in a similar form in the customer list in the knowledge base”.

The data to be found and also the criteria should be in a hierarchical order so that during recognition reference can be made to the results of previous partial processes and in this way the complexity can be reduced and the probability of recognising a specific datum can be increased.

If for example the customer has already been found, a criterion for identifying the receiver of the goods (example: R₂=receiver of goods) might run as follows: “the company address specified in the hypothesis is found in the customer list in the knowledge base in this form or in a similar form and, if Rl has been successfully found, in the list of addresses of receivers of goods associated with this customer”.

Output module 160 checks whether all the data to be found (R₁ to Rₘₐₓ) have been found by the component “Dynamic Recognition” 140. If the answer is yes, the data found (R₁ to Rₘₐₓ), are passed on to the transmission module 400, and if not they are passed on to the module 300 for manual enhancement.

As an illustration, a simple example with fictional data, hypotheses, criteria etc. will be described more fully:

R₁ is the customer (sold-to), R₂=Rₘₐₓ is the receiver of the goods (ship-to).

Rules in module 130 state that it must be a sequence of letters beginning with a capital letter. In the document converted into a file by module 110, module 120 finds the words “Meier”, “Muller” and “Schulze” which conform to this rule. These names therefore form the hypotheses: H₁(R₁): customer=“Meier”, H₂(R₁): customer=“Muller”, H₃(R₁): customer=“Schulze”.

The first exploratory criterion might be: the customer specified in the hypothesis is present in the customer databank in the knowledge base (module 200). For the first hypothesis the check finds a “Meier GmbH” in the knowledge base. Fuzzy testing produces a value of for example 0.8 for the correctness of the value “Meier” from hypothesis H₁(R₁). As the confidence interval for this criterion is 0.6 to 1, the hypothesis stands up to examination.

With H₂(R₁) only the value “Obermüller AG” is found, which is given a marking of 0.4. Thus the results are outside the confidence limits. Hypothesis H2(R1) is therefore rejected.

With H₃(R₁) the hypothesis again holds, which means that 2 hypotheses are left.

The second exploratory criterion would result in only the hypothesis H₁(R₁) remaining, analogously to the procedure described above. Meier GmbH would thus be accepted as the customer. However, there is still one exploratory criterion left. This would be applied to Meier GmbH. Meier GmbH also stands up to this criterion. Thus, the exploratory criterion has been so-to-speak converted into a confirmatory criterion. Other exploratory criteria would also be used accordingly before the checking of Meier GmbH with the confirmatory criteria was continued. If the hypothesis also stands up to this, the recognition of R₁ is true and the result is the customer number of Meier GmbH, such as “4711”. A system design is also possible in which the confirmatory use of criteria with a negative test result does not immediately lead to rejection of the hypothesis but goes into an evaluation parameter of the hypothesis quality which is compared with a corresponding confidence interval after all the criteria have been gone through and only results in rejection of the hypothesis below a confidence threshold.

Exactly the same procedure is followed for R₂ except that here the information that Meier GmbH is the customer can be used. In searching for the receiver of the goods the knowledge base can be restricted, for example, to the receivers of the goods associated with customer 4711, namely Meier GmbH.

If a customer were found, output component 160 would establish that both the elements looked for have been found. The information would then be passed not to module 300 for finishing but to module 400 for further processing.

The workstation module 300 receives from the output 160 of the module 100 the data sets in which not all the data have been fully recognised. The operator has the option of manually checking on any unrecognised data fields on screen. For this purpose the system supplies him with the original document either as a soft copy, i.e. on screen, or as a hard copy, e.g. in the form of a paper printout, depending on the system design. The operator then has the opportunity to work out what value has to be entered into the corresponding field and inputs the corresponding data into the module 300. Depending on the design of the module he may be offered a choice of options based on the hypotheses generated in component 120. Once the amendment has successfully made the workstation module 300 passes the data on to the transmission module 400.

If for example the quantity ordered has not been determined, the operator looks for this in the original document and adds it to the data set using the interface in the work place module 300. If no other data are missing the module then passes the data on to the module 400 as described.

The transmission module 400 receives the completed data from the module 100 or 300. Depending on the system design, in some cases, the data are not complete enough to allow a business procedure, in our example an order, to be initiated in an ERP system. Component 410 enhances the data record using information defined as essential in a combination of data as in the data set. This might be for example a warehouse which has to be used for a specific customer-product combination, in order to dispatch the goods.

After the data set has been enhanced it has to be converted in component 420 into a format which the ERP system is capable of processing in module 500. If for example a SAP R/3 type system is used in module 500, component 420 converts the data set into an SAP Intermediate Document (IDoc), for example.

Component 430 sends the results to the ERP system and in the embodiment described it thus sends the IDoc to the SAP R/3 system.

The ERP system (Module) 500 describes an ERP system which has at least the conventional commercial functions. An example of such a system is the model R/3 made by Messrs SAP.

The ERP system must be capable of receiving data sets which it obtains from component 430 for processing. For this it needs an interface which processes the format generated, in this particular instance an interface which can process IDocs (component 510). As the other functions are not part of the system described here but are commercially available there is no need to describe them further at this point. An exception is component 520: the knowledge base (module 200) has to have the possibility of accessing the defined information from the ERP system. Depending on the design of the system this is done by direct (online) access of the knowledge base to the data maintenance in the ERP system, i.e. for example the data warehouse of SAP, or through a periodic or occasional download of the relevant information directly into the databank of the knowledge base. It must therefore be ensured that the data warehouse required is supplied with the necessary data from module 500.

In the case of an order over the telephone according to the invention the following procedure is adopted according to a preferred embodiment:

The system according to the invention comprises an interactive call answering device known per se which welcomes the customer as he calls and takes him through the ordering procedure, wherein the customer's details are acquired by keying in or speech.

The customer quotes, in the correct order, his customer number and/or an identification and authorisation number (PIN), and it should be noted that the invention will also operate without the PIN number on the basis of the recognition system described above.

The customer can then state whether this is a new order or a follow-up to instructions which have already been placed (amendment or cancellation). In the case of a new order the customer quotes the goods receiver number, customer order number, item number, desired quantity and desired delivery date. In the case of a change to an order or cancellation the customer quotes the order number which the supplier has already provided him with at this time and says whether it is a change or a cancellation. If there is a change he then specifies the new amount and/or a new delivery date.

According to the invention, the customer then hears a summary of the information he has provided. In the event of a spoken order his recorded speech is “played back” by the call answering machine, i.e. replayed, while in the event of an order which has been keyed in the customer hears a spoken message which is electronically generated by the keystrokes. The customer then has the opportunity to make any changes, place further orders and/or confirm the order.

Once the telephone ordering process has ended the customer details are taken into the in-house ordering system and checked for the plausibility of the instructions as explained in detail hereinbefore. Once the check has been run the customer receives an automatically generated confirmation of the order by electronic mail or fax.

According to a particularly advantageous embodiment of the invention, the telephone details provided by the customer are checked in parallel while the order is being placed so that even during the telephone ordering process the customer can be given automatic feedback to say whether his order (or request for a change or cancellation) has been accepted and the job number which the instructions have been allocated.

Another possible alternative is for the customer to telephone to enquire as to the status of his order, by quoting the job number which he will know by this time and receiving from the ordering system (ERP system) a reply as to whether the order is still outstanding (i.e. not yet produced or dispatched), has been allocated (i.e. has been produced but not yet sent out) or has already been sent out.

The invention thus makes it possible for customers using a continuous text, otherwise unformatted text, the telephone or even using their own order forms, to carry out business processes which can be fully and correctly recognised at the supplier end and further processed with no or only minimal human intervention.

1-12. (canceled)

13. Process for the computer-implemented evaluation of electronic business processes using a computer system, wherein in order to check business process-related data contained in a business process (GP) input into the computer system, electronically recognized data elements are compared with customer- and/or material-specific data contained in a knowledge base (200), comprising the following steps:
converting or reformatting the data contained in the input business process (GP) into a text filed,
in a first checking step, carrying out a static check on the data on the basis of character recognition and drawing up hypotheses as to the contents of each datum checked by taking onto account rules on the semantic context of information relevant to the drawing up of the hypotheses,
in a second checking step, carrying out a dynamic check of the hypotheses elaborated using stored criteria and rules, with reference to the knowledge base (200).

14. Process according to claim 13, wherein if a recognized business process-related datum does not agree with data in the knowledge base (200) the business process-related datum is corrected on the basis of the contents of the knowledge base (200).

15. Process according to claim 13, wherein the business process (GP) is passed on to an enhancement module (300) for manual enhancement, if a correction cannot be made on the basis of the contents of the knowledge base (200).

16. Process according to claim 13, wherein business processes are input electronically by electronic mail, fax, OCR character recognition and/or telephone.

17. Process according to claim 13, wherein recognized business process-related data are automatically passed on to a job processing system (500) which runs the business process fully automatically on the basis of these data.

18. Computer system for computer-implemented evaluation of electronic business processes, having an input interface, a recognition module (100), a knowledge base (200), a transmission module (400) and a job processing system (500), wherein in order to check business process-related data contained in a business process (GP) input into the computer system via the input interface, electronically recognized data elements are compared with customer- and/or material-specific data contained in a knowledge base (200), while first of all the data contained in the input business process (GP) is converted or reformatted into a text file and in order to check business process-related data in the text file in the recognition module (100), in a first checking step (120), a static check is carried out on the data on the basis of character recognition and hypotheses are elaborated as to the contents of each datum checked, taking into account rules on the semantic context of information relevant to the drawing up of the hypotheses, information relevant to the drawing up of the hypotheses, and in a second checking step (140), a dynamic check is carried out on the hypotheses elaborated using stored criteria and rules, with reference to the knowledge base (200).

19. Computer system according to claim 18, wherein if a recognized business process-related datum does not agree with data in the knowledge base (200) the business process-related datum is corrected on the basis of the contents of the knowledge base (200).

20. Computer system according to claim 19, which further comprises an enhancement module (300) used for manually enhancing business process data if a correction to the business process-related datum cannot be made on the basis of the contents of the knowledge base (200).

21. Computer system according to claim 18, wherein business processes are input electronically by electronic mail, fax, OCR character recognition and/or telephone.

22. Computer system according to claim 18, wherein business process-related data recognized by the recognition module (100) are automatically passed on to the job processing system (500) by the transmission module (400) and the job processing system (500) runs the business process fully automatically on the basis of these data.

23. Computer program product having a computer-readable medium and a computer program stored on the computer-readable medium, with program coding means which are adapted to execute a process according to claim 13 when the computer program is run on a computer system.

24. Computer program with program coding means, which are adapted to execute a process according to claim 13 when the computer program is run on a computer system.
